(19) United States
(12) Patent Application Publication
(10) Pub. No.: US 2011/0285985 A1
(43) Pub. Date: Nov. 24, 2011

(54) Method for Analyzing Sample and Microanalysis Chip to be used Therefore

(76) Inventor: Mika Honda, Tokyo (JP)

(21) Appl. No.: 13/146,170

(22) PCT Filed: Dec. 2, 2009
(86) PCT No.: PCT/JP2009/070225

§ 371 Date: Jul. 25, 2011

(30) Foreign Application Priority Data
Feb. 12, 2009 (JP) 2009-029566

(51) Int. Cl. G01N 21/59; G01N 21/17

(52) U.S. Cl. 356/51

(57) ABSTRACT

In the present invention, microanalysis chip 1 possesses resin substrate 20 in which a groove (flow path 22) is formed, and resin film 10 to cover the groove (flow path 22), and at least one of a substrate (resin substrate 20) and a lid body (resin film 10) is made of a cycloolefin resin to realize not only accurate position alignment and confirmation of presence or absence of reaction with visible light or fluorescence, but also accurate sample analysis with terahertz light.

### TECHNICAL FIELD

The present invention relates to a sample analyzing method and a microanalysis chip to be used therein.

### BACKGROUND

In recent years, sample analysis in which a microanalysis chip is used has been conducted, and properties of even a small amount of sample can be designed to be sufficiently analyzed by pouring the sample into a flow path formed in the chip, and exposing it to light. For example, Patent Document 1 has disclosed a disposable type microanalysis chip formed of PDMS (polydimethyl siloxane), and Patent Document 2 has disclosed not only usable PMMA (polymethyl methacrylate) in addition to PDMS as a constituent material constituting the chip, but also a technique in which terahertz light is used as light for analysis.

“Terahertz light” exhibiting a longer wavelength than the wavelength region of infrared light (approximately from 100 μm to 1 mm) is referred to as light in the terahertz wavelength region located between radio waves and light.

Since vibrations of terahertz light are more relaxed than those of infrared light, the vibrations of terahertz light are not interatomic local vibrations in molecules, but correspond to vibrations between groups of atoms in a sense. Accordingly, presence of molecules per se can be clearly identified via detection of the vibrations between groups of atoms by using terahertz light, and in the case of terahertz spectroscopy, and molecules can be identified with one frequency of absorption lines, whereas in the case of infrared spectroscopy, presence of molecules is inferred by using a large number of local vibrations in combination (refer to Patent Document 3).

Incidentally, in cases where terahertz light is used as light for analysis, terahertz light exhibits a property in which it is generally absorbed by water, and a sample filled in a flow path is preferably cooled and frozen in order to reduce influence by water when analyzing the sample in a chip (sample filled in a flow path in the chip). For example, water has a small absorption coefficient α (cm⁻¹) of 3.50×10⁻⁴ with respect to visible light having a wavelength of 550 nm, and appears to hardly absorb visible light, resulting in transparency. However, water has a large absorption coefficient α (cm⁻¹) of 2.69×10² with respect to terahertz light having a wavelength of 250 μm, and it appears to be difficult for terahertz light to pass through water (refer to Nonpatent Document 1). When cooled and frozen, ice has an absorption coefficient α (cm⁻¹) of 1.07×10 with respect to light having a wavelength of 250 μm, which is one twenties of absorption coefficient a in a state of water, whereby analysis ability appears to be largely improved by cooling and freezing a sample for analysis with terahertz light.

In addition, since terahertz light can not be visibly confirmed, it is difficult to adjust positions in the optical system. For this reason, in cases where analysis is carried out employing terahertz light. It is desired to make primary adjustment with visible light, and subsequently to replace the light source with the other. Further, in cases where molecule analysis is carried out employing fluorescent Imaging with visible light, microscopic observation and terahertz light, they should be utilized in a complementary style since the resulting information is different from each other. For this reason, it is desirable that an optical system of visible light is installed inside the same apparatus for analysis with terahertz light.

### PRIOR ART DOCUMENT

### Patent Document

Patent Document 1: Japanese Patent O.P.I. (Open to Public Inspection) Publication No. 2001-157855

Patent Document 2: Published Japanese Translation of PCT International Publication No. 2008-509391

Patent Document 3: Japanese Patent O.P.I. Publication No. 2008-197081 (Paragraph 0012)

### Nonpatent Document

Nonpatent Document 1: “Optical Absorption of Water Compendium”, (online), (searched in Jan. 20, 2009), Internet <URL: http://omlc.ogi.edu/spectra/water/abs/index.html>

### DISCLOSURE OF THE INVENTION

### Problems to be Solved by the Invention

However, when a sample filled in a flow path is frozen, and then a chip itself is also cooled and frozen, the chip is impregnated with water in cases where the chip is formed of PDMS or PMMA exhibiting water absorption, whereby a milky white phenomenon called crack is generated inside the chip. In this case, when analyzing a sample with visible light (microscopic observation), accurate analysis can not be carried out since the chip becomes cloudy. Further, in cases where the follow path of a microanalysis chip is fine, the position alignment of the microanalysis chip is made by using visible light at a stage prior to analyzing a sample with terahertz light, and presence or absence of reaction of a liquid sample inside the microanalysis chip is checked with fluorescence (employing a fluorescence microscope). Also in this case, in cases where a chip becomes milky white, the accurate position alignment and presence or absence of reaction can not be confirmed.

Accordingly, it is an object of the present invention to provide a microanalysis chip by which not only accurate position alignment and confirmation of presence or absence of reaction with visible light or fluorescence, but also accurate sample analysis with terahertz light can be realized, and to provide a sample analyzing method employing the microanalysis chip.

### Means to Solve the Problems

In an embodiment of the present invention, provided is a sample analyzing method employing a microanalysis chip comprising a substrate in which a groove is formed, and a lid body to cover the groove, one selected from the group consisting of the substrate and the lid body, the one made of a cycloolefin resin, comprising step 1 of exposing a sample to visible light passing through the one, and making light transmitted or reflected from the sample to pass through the one to conduct sample analysis via measurement of the transmitted visible light; and step 2 of making terahertz light to pass through the substrate or the lid body to expose the sample to the terahertz light, and making light transmitted or reflected from the sample to pass through the lid body or the substrate to conduct sample analysis via measurement of the transmitted light.

In another embodiment of the present invention, provided is a microanalysis chip employed in the above-described sample analyzing method, comprising the substrate in which the groove is formed, and the lid body to cover the groove, wherein at least one of the substrate and the lid body is made of a cycloolefin resin.

### Effect of the Invention

In the present invention, generation of cracks inside a chip can be avoided, and realized can be not only confirmation of accurate position alignment with visible light or fluorescence and of presence or absence of reactor, but also accurate sample analysis with terahertz light.

### BRIEF DESCRIPTION OF THE DRAWINGS

FIG. 1 is an oblique perspective view showing a schematic outline configuration of a microanalysis chip in the preferred embodiment of the present invention.

FIG. 2 is a plan view showing a schematic outline configuration of a substrate (substrate made of resin) used in the preferred embodiment of the present invention.

FIG. 3 shows a cross-sectional view along an I-I line.

FIG. 4 is a diagram showing a schematic outline configuration of an analysis system (transmission type) in which the microanalysis chip of FIG. 1 is used.

FIG. 5 is a diagram showing a schematic outline configuration of a modified example of FIG. 4.

FIG. 6 is a diagram showing a schematic outline configuration of an analysis system (reflection type) in which the microanalysis chip of FIG. 1 is used.

FIG. 7 is a diagram showing a schematic outline configuration of a modified example of FIG. 6.

### DESCRIPTION OF THE PREFERRED EMBODIMENTS

Next, the preferred embodiments of the present invention are described referring to drawings.

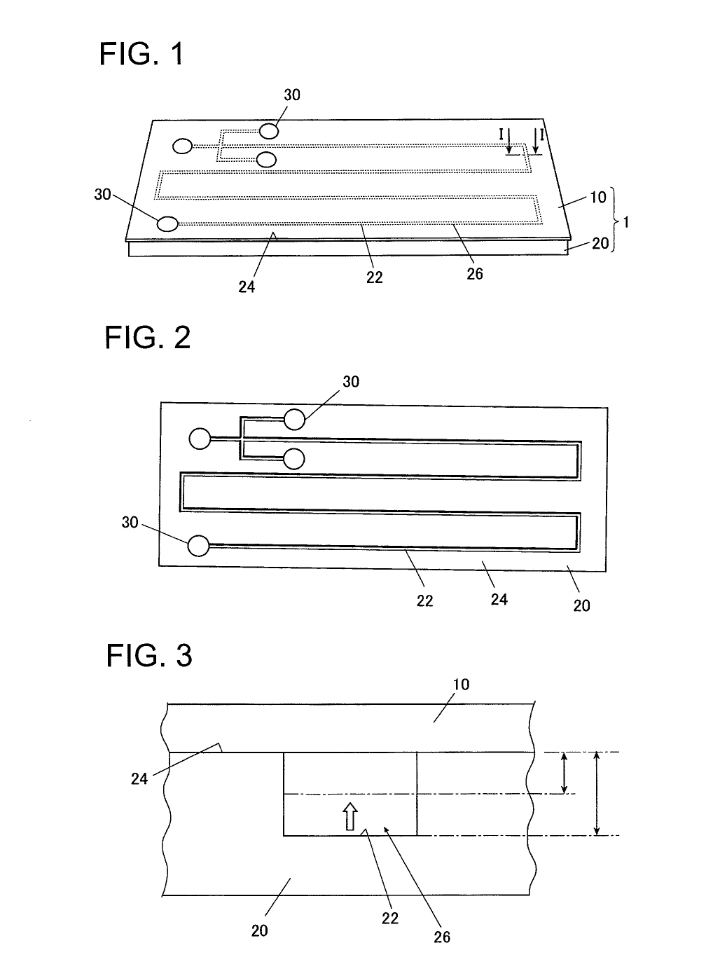

As shown in FIG. 1 and FIG. 2, microanalysis chip 1 possesses resin substrate 20 (substrate) and provided thereon, resin film 10 (lid body). Resin film 10 is a member in the form of a sheet, and resin substrate 20 is a nearly cuboid-shaped member.

As shown in FIG. 1 and FIG. 3, flow path groove 22 (groove) is formed to resin substrate 20, and resin film 10 is attached on the surface (bonding plane 24) where flow path groove 22 (groove) is formed.

As to microanalysis chip 1, resin film 10 serves as a lid body (cover) to cover a groove (flow path groove 22), and fine flow path 26 is formed from resin film 10 and flow path groove 22. Specifically, fine flow path 26 is formed from the inner wall surface of flow path groove 22 and the lower surface of resin film 10.

As shown in FIG. 1 and FIG. 2, plural inflow•outflow openings 30 pass through resin film 10, and are communicated into a start point, an end point, a midway portion and so forth. In the situation where resin film 10 is bonded to resin substrate 20 as a substrate, inflow•outflow openings 30 serve as openings through which fine flow path 26 is connected to the exterior. Inflow•outflow openings 30 are in the form of a circle, but they may be rectangular, and be in the form of another shape.

As to microanalysis chip 1, inflow•outflow openings 30 are employed to introduce, store and discharge a liquid sample (gel, a buffer solution and others) or the like. Specifically, a tube and a nozzle provided in an analyzer (unshown) are connected to inflow•outflow openings 30, and the liquid sample or the like is introduced into fine flow path 26, or discharged from fine flow path 26 via the tube or the nozzle.

In addition, usable liquid samples in the present embodiment are used as living body specimens, examples thereof include blood, tear fluid, sativa, bone marrow, urine, sweat, runny nose, semen and so forth. Of course, the usable liquid samples are not limited to living body specimens, and used may be chemicals, seawater, tap water, lake water, ground water, river water and so forth.

At least one of resin film 10 (cover) and resin substrate 20 (substrate) is made of a cycloolefin resin.

ZEONEX produced by Zeon Corp., APEL produced by Mitsui Chemicals, Inc. and TOPAS produced by Ticona are commercially available as the cycloolefin resin.

Kinds of resins constituting each of resin film 10 (cover) and resin substrate 20 (substrate) may be identical to each other, and be different from each other.

A resin having a structural unit, which is represented by the following formula, for example, is cited as a cycloolefin resin.

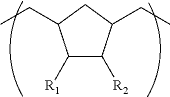

, where each of R₁ and R₂ represents a hydrogen atom or alkyl.

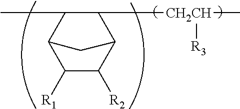

, where each of R₁, R₂ and R₃ represents a hydrogen atom or alkyl.

The cycloolefin resin preferably has a water absorption coefficient of 0.01% or less. When the constituent material constituting each of resin film 10 and resin substitute 20 has a water absorption coefficient of 0.01% or less, deformation and damage of a chip caused by internal stress can be surely inhibited when cooling and freezing a liquid sample during analysis of samples.

In the present invention, water absorption coefficient means a value measured in accordance with MS K7209 “how to determine plastic-water absorption coefficient”.

The external shapes of resin film 10 and resin substrate 20 are rectangular, but they may be those to be easily handled and also to be easily analyzed. Resin film 10 and resin substrate 20 are preferably square-shaped or rectangle-shaped, and the size is a square, 10-200 mm on a side and preferably a square, 10-100 mm on a side.

The cross-sectional shape of fine flow path 26 preferably has a width of 30-200 μm and a depth of 30-200 μm in consideration of a reducible consumption amount of the liquid sample together with precision in die preparation, transferability, a releasing property and so forth.

The width and depth of fine flow path 26 may be determined via application of microanalysis chip 1.

The cross-sectional shape of fine flow path 26 may be rectangular, or curved surface-shaped.

Resin film 10 (member in the form of a sheet) preferably has a thickness of 30-300 μm, and more preferably has a thickness of 50-150 μm.

On the other hand, resin substrate 20 preferably has a plate thickness of 0.2-5 mm, and more preferably has a plate thickness of 0.2-2 mm in view of a molding property.

Next, a method of manufacturing a microanalysis chip will be described.

Resin film 10 to which inflow•outflow openings 30 have been formed in advance is prepared, and a thermoplastic resin is subsequently injection-molded to prepare resin substrate 20 having flow path groove 22 thereto.

Then, resin film 10 is attached onto bonding surface 24 of resin substrate 24, and resin film 10 and resin substrate 20 are bonded to each other via thermal fusion bonding.

Resin film 10 and resin substrate 20 are bonded to each other via heating, employing, for example, a heat plate, heat air, a heat roll, ultrasonic waves, vibrations, laser or the like. As an example, resin film 10 and resin substrate 20 are sandwiched between heated plates employing a heat press machine, and maintained while applying pressure from the heated plates to bond resin film 10 and resin substrate 20 to each other.

Next, a sample analyzing method employing microanalysis chip 1 will be described.

A sample analyzing method employing a microanalysis chip possessing a substrate in which a groove is formed, and a lid body to cover the groove possesses step 1 of exposing the sample to visible light passing through one selected from the group consisting of the substrate and the lid body, the one made of a cycloolefin resin, and making light transmitted or reflected from the sample to pass through the one to conduct sample analysis via measurement of the transmitted visible light; and step 2 of making terahertz light to pass through the substrate or the lid body to expose the sample to the terahertz light, and making light transmitted or reflected from the sample to pass through the lid body or the substrate to conduct sample analysis via measurement of the transmitted light.

As the configuration of an analysis system used in the sample analyzing method, as described below, there are a transmission type configuration to conduct analysis via detection of light passing through the sample, and a reflection type configuration to conduct analysis via detection of light reflected from the sample.

In order to possess the above-described step 1, the analysis system configuration in the above-described step 1 is designed to be the reflection type, or it is necessary to make any of the substrate and the lid body to be made of a cycloolefin resin.

In the above-described step 2, any of the transmission type and the reflection type is usable as the analysis system configuration, but in the case of the transmission type, both the substrate and the lid body are preferably made of a cycloolefin resin, but in cases where one of them is not made of a cycloolefin resin, the remaining one of them is preferably made of a fluorine resin having a low water absorption coefficient.

The above-described step 2 is preferably step 2 of making terahertz light to pass through the substrate or the lid body made of the cycloolefin resin to expose the sample to the terahertz light, and making light transmitted or reflected from the sample to pass through the substrate or the lid body to conduct sample analysis via measurement of the transmitted light in view of being exposed to visible light and the terahertz light from the same side.

The specific method will now be described.

First, a liquid sample is introduced into flow path groove 22 of microanalysis chip 1 to generate reaction for sample analysis, and microanalysis chip 1 is subsequently cooled to freeze the liquid sample in flow path groove 22.

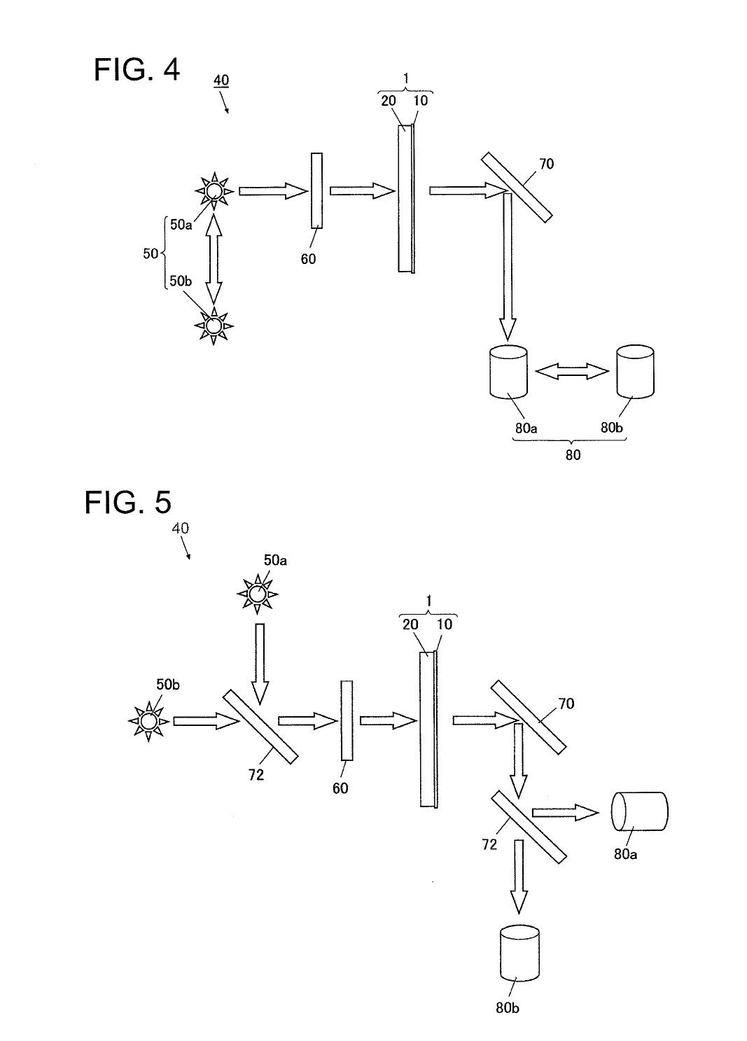

Thereafter, specific analysis of a liquid sample in microanalysis chip 1 is conducted employing the predetermined analysis systems (40 and 45) shown in FIGS. 4-7.

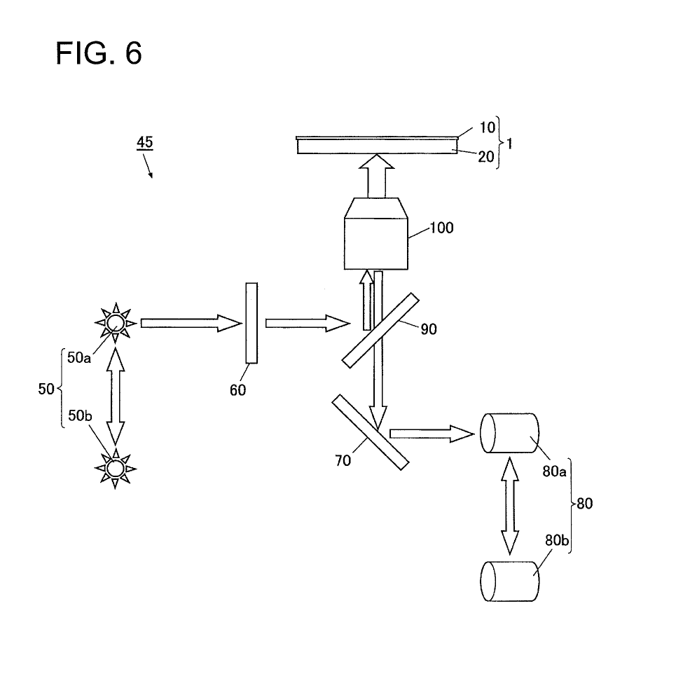

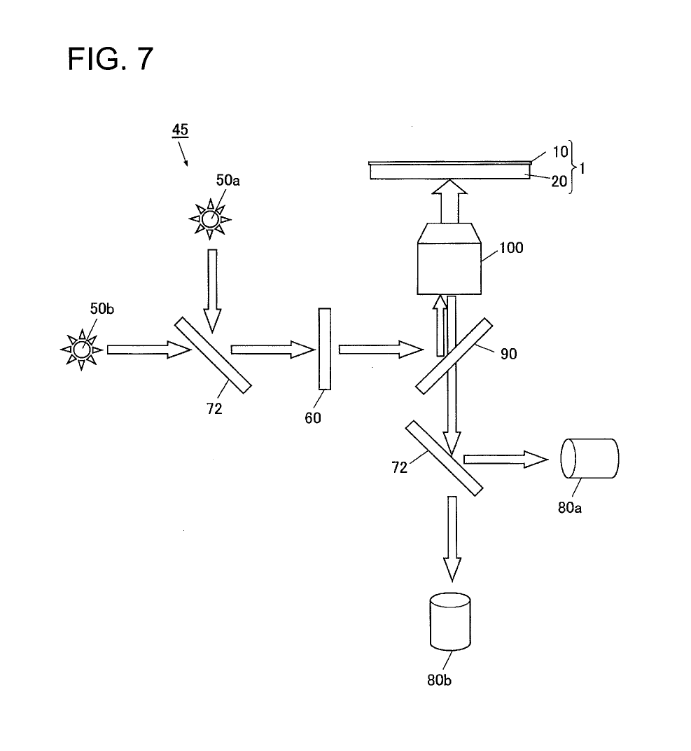

The configuration of an analysis system used in the sample analyzing method is classified into “transmission type (refer to FIG. 4 and FIG. 5)” by which light is transmitted into a liquid sample in microanalysis chip 1 to analyze the liquid sample, and “reflection type (refer to FIG. 6 and FIG. 7)” by which light is reflected at a liquid sample in microanalysis chip 1 to analyze the liquid sample, and the liquid sample in microanalysis chip 1 is optically analyzed with either one of the two types.

Sample analysis methods with transmission type analysis system 40 and reflection type analysis system 45 are separately explained below.

### [Transmission Type]

As shown in FIG. 4, in transmission type analysis system 40, light source 50, filter 60 and reflection mirror 70 are linearly placed, and detector 80 is placed at the location where light reflected from reflection mirror 70 is receivable.

Optical source 50 possesses visible light source 50a to emit visible light (visible light source 50a is also possible to emit fluorescence included in the visible light wavelength region) and terahertz light source 50b to emit terahertz light, and either one of the two is used in analysis system 40. In the case of light source 50, visible light source 50a and terahertz light source 50b are rotated like a revolver, whereby their positioning locations appear to be replaceable.

Further, in response to light source 50, detector 80 also possesses visible light detector 80a to detect visible light and terahertz light detector 80b to detect terahertz light, and visible light detector 80a and terahertz light detector 80b are rotated like a revolver in response to light source 50 to be used (visible light source 50a or terahertz light source 50b), whereby their positioning locations appear to be replaceable.

When practically conducting sample analysis with transmission type analysis system 40, microanalysis chip 1 is placed in the predetermined location between filter 60 and reflection mirror 70, and presence or absence of reaction of the liquid sample in microanalysis chip 1, and so forth are confirmed.

Specifically employing visible light source 50a as light source 50, visible light is emitted from visible light source 50a and the visible light is received by visible light detector 80a to align microanalysis chip 1, and fluorescence is emitted from visible light source 50a and the fluorescence is received by visible light detector 80a to confirm presence or absence of the liquid sample in microanalysis chip 1.

In this case, visible light and fluorescence pass through each of filter 60 and microanalysis chip 1; are reflected at reflection mirror 70; and are detected by visible light detector 80a.

Then, employing terahertz light source 50b as light source 50, terahertz light is emitted from terahertz light source 50b and the terahertz light is received by terahertz light detector 80b to optically analyze the liquid sample in microanalysis chip 1.

In this case, similarly to the above-described visible light and fluorescence, terahertz light pass through each of filter 60 and microanalysis chip 1; is reflected at reflection mirror 70; and is detected by terahertz light detector 80b.

In addition, transmission type analysis system 40 may take the configuration in FIG. 5.

That is, as shown in FIG. 5, mirror 72 made of Si is placed between light source 50 (each of 50a and 50b) and filter 60, and mirror 72 made of Si is placed between reflection mirror 70 and detector 80 (each of 80a and 80b). Mirror 72 made of Si exhibits a property in which visible light and fluorescence are reflected by the mirror, but terahertz light is transmitted by the mirror. Light source 50 (each of 50a and 50b) and detector 80 (each of 80a and 80b) are secured in the predetermined location with respect to mirror 72 made of Si.

As to analysis system 40 in FIG. 5, in cases where visible light source 50a is used as light source 50, visible light and fluorescence are reflected at mirror 72 made of Si; pass through each of filter 60 and microanalysis chip 1; are reflected at reflection mirror 70; are further reflected at mirror 72 made of Si; and are detected by visible light detector 80a.

On the other hand, in cases where terahertz light source 50a is used as light source 50, terahertz light passes through each of mirror 72 made of Si, filter 60 and microanalysis chip 1; is reflected at reflection mirror 70; further passes through mirror 72 made of Si; and is detected by terahertz light detector 80b.

### [Reflection Type]

As shown in FIG. 6, in the case of reflection type analysis system 45, light source 50, filter 60 and dichroic mirror 90 are linearly placed. Objective lens 100 is placed in the location where light reflected from dichroic mirror 90 is receivable, and reflection mirror 70 is placed in the location where light transmitted from dichroic mirror 90 is receivable. Detector 80 is placed in the location where light reflected from reflection mirror 70 is receivable.

When practically conducting sample analysis with reflection type analysis system 45, microanalysis chip 1 is placed facing (position-aligned), and presence or absence of reaction of the liquid sample in microanalysis chip 1, and so forth are confirmed.

Specifically employing visible light source 50a as light source 50, visible light is emitted from visible light source 50a and the visible light is received by visible light detector 80a to align microanalysis chip 1, and fluorescence is emitted from visible light source 50a and the fluorescence is received by visible light detector 80a to confirm presence or absence of the liquid sample in microanalysis chip 1.

In this case, visible light and fluorescence pass through filter 60; are reflected at dichroic mirror 90; and pass through objective lens 100. Then, the visible light and the fluorescence pass through resin substrate 20 provided in microanalysis chip 1; are reflected at the liquid sample; pass through resin substrate 20 again; and pass through objective lens 100. The visible light and the fluorescence pass through dichroic mirror 90; are reflected at reflection mirror 70; and are detected by visible light detector 80a.

Then, employing terahertz light source 50b as light source 50, terahertz light is emitted from terahertz light source 50b, and the terahertz light is received by terahertz light detector 80b to optically detect a liquid sample in microanalysis chip 1.

In this case, similarly to the above-described visible light and fluorescence, terahertz light passes through resin substrate 20 via filter 60, dichroic mirror 90 and objective lens 100; is reflected; and is detected by terahertz light detector 80b via objective lens 100, dichroic mirror 90 and a reflection mirror.

In addition, similarly to transmission type analysis system 45, reflection type analysis system 45 may also take the configuration in FIG. 7 similar to FIG. 5.

That is, as shown in FIG. 7, mirror 72 made of Si is placed between light source 50 (each of 50a and 50b) and filter 60, and mirror 72 made of Si is placed in place of reflection mirror 70.

In the case of analysis system 45 in FIG. 7, in cases where visible light source 50a is used as light source 50, visible light and fluorescence are reflected at mirror 70 made of Si; pass through filter 60; is reflected at dichroic mirror 90; and pass through objective lens 100. Then, the visible light and the fluorescence pass through resin substrate 20 in microanalysis chip 1; are reflected at a liquid sample; pass through resin substrate 20 again; and pass through objective lens 100. Subsequently, the visible light and the fluorescence pass through dichroic mirror 90; are reflected at mirror 72 made of Si; and are detected by visible light detector 80a.

On the other hand, in cases where terahertz light source 50b is used as light source 50, terahertz light passes through resin substrate 20 via mirror 72 made of Si, filter 60, dichroic mirror 90 and objective lens 100; is reflected; and is detected by terahertz light detector 80b via objective lens 100, dichroic mirror 90 and mirror 72 made of Si.

In addition, microanalysis chip 1 in the present embodiment is a disposal type one, and is replaced by new microanalysis chip 1 after completing analysis of one liquid sample, whereby the same sample analysis as described above can be repeated.

In this case, microanalysis chip 1 (resin film 10 with resin substrate 20) is light, strong against shock caused by falling and so forth, and easy to be handled since the microanalysis chip is made of a cycloolefin resin.

In the present embodiment as described above, since resin film 10 and resin substrate 20 are made of a cycloolefin resin, position alignment as well as fluorescence observation employing visible light, and identification of molecules employing terahertz light can be simultaneously conducted, and accurate position alignment employing visible light as well as confirmation of presence or absence of reaction employing fluorescence, and accurate sample analysis employing terahertz light can be realized.

That is, since PDMS and PMMA exhibit a water absorption property and a moisture absorption property in cases where each of resin film 10 and resin substrate 20 are made of PDMS or PMMA, crack (milky white) is generated when resin film 10 and resin substrate 20 are cooled and frozen by impregnating water content in the resin, resulting in influence on the optical measurements employing visible light and fluorescence or terahertz light.

In contrast, in the present embodiment, since resin film 10 and resin substrate 20 are made of a cycloolefin exhibiting low water absorption and moisture absorption, the crack is difficult to be produced, and accuracy in optical measurement employing terahertz light can be improved.

In addition, during analysis of a liquid sample (during cooling•freezing), terahertz light is absorbed in the liquid sample in fine flow path 26, and in cases where an amount of the terahertz light detected by terahertz light detector 80b is lowered, the detection amount of terahertz light may be designed to be increased by making the depth of flow path groove 22 of resin substrate 20 to be a shallow depth of roughly 10-30 μm.

In this case, since an optical path transmitted in the liquid sample by terahertz light is shortened, an absorption amount of terahertz light into the liquid sample is lowered, whereby analysis ability of the liquid sample employing terahertz light can be improved.

Further, since resin substrate 20 is prepared via injection-molding by making the resin substrate to be made of a cycloolefin resin, microanalysis chip 1 is generally possible to be mass-produced, and a chip having not only high quality but also evenness in quality can be supplied.

In cases where flow path groove 22 is specifically formed, fine flow path groove 22 can be easily formed by an amount equivalent to the unnecessary processing such as etching or the like in comparison to glass which is difficult to be subjected to processing, and flow path groove 22 can be rapidly formed in comparison to PDMS which consumes a longer time for thermosetting.

Further, since microanalysis chip 1 is a disposable type for each sample analysis, the same microanalysis chip 1 as employed before is not necessary to be repeatedly used, whereby influence to a human body such as living body contamination or the like connected from the liquid sample.

In addition, in the present embodiment, both resin film 10 and resin substrate 20 are made of a cycloolefin resin, but at least one of both resin film 10 and resin substrate 20 may be made of a cycloolefin resin.

That is, in the case of reflection type analysis system 45, either one of the two (resin film 10 and resin substrate 20) may be made of glass, a PDMS resin, a PMMA resin, an acrylic resin or the like.

Specifically, in cases where microanalysis chip 1 is used in transmission type analysis system 40 together with visible light, fluorescence or terahertz light, visible light, fluorescence and terahertz light pass through both of resin film 10 and resin substrate 20, whereby these visible light, fluorescence and terahertz light are affected from both members. Therefore, in this case, both resin film 10 and resin substrate 20 should be made of a cycloolefin resin.

In contrast, in cases where microanalysis chip 1 is used in reflection type analysis 45 together with visible light, fluorescence or terahertz light, visible light, fluorescence and terahertz light pass through only resin substrate 20, whereby these visible light, fluorescence and terahertz light are affected from only resin substrate 20. Therefore, in the case of reflection type analysis system 45, there appears no problem in the sample analysis, even though any resin substrate 20 is made of a cycloolefin resin, and resin film 10 is made of a resin other than the cycloolefin resin.

In addition, in the case of analysis systems 40 and 45, the direction of the location of resin substrate 20 fitted with resin film 10 may be inverted with respect to the above-described. In this case, in the case of the reflection type analysis, resin film 10 may be made of a cycloolefin resin.

### EXAMPLE

### (1) Preparation of Sample

### (1.1) Sample 1

A film made of a fluorine resin {Cytop (product name), produced by Asahi Glass Co., Ltd.} as a transparent resin material is formed as a film having a thickness of 75 μm, and cut as the film having a length of 25 mm to form a resin film.

A cycloolefin polymer as a transparent resin material (Zeonex 330R, produced by Zeon Corporation: COP1 in Table 1, and a water absorption coefficient of 0.007%) was molded by an injection molding machine, and prepared was a resin substrate in the form of a plate-shaped member having a width of 25 mm, another width of 25 mm and a thickness of 1 mm in external dimension, which possesses a flow path having a width of 30 μm and a depth of 30 μm, and inflow•outflow openings having an inner diameter of 2 mm. Herein, 30 μm in depth for the flow path groove was defined as a design value of the flow path.

Thereafter, the resin film was layered on a bonding surface (surface in which the flow path groove is formed) of a resin substrate. Then, in this situation, employing a heat press machine, the resin substrate and the resin film were sandwiched between plates heated to a press temperature of 82° C., and maintained for 30 seconds via application of a pressure of 38 kgf/cm² to bond the resin substrate to the resin film. “Sample 1 (microanalysis chip)” was prepared via this bonding.

### (1.2) Sample 2

“Sample 2” was prepared similarly to preparation of Sample 1, except that the material constituting the resin film in Sample 1 was replaced by a cycloolefin polymer (COP1).

### (1.3) Sample 3

“Sample 3” was prepared similarly to preparation of Sample 1, except that the resin film in Sample 1 was replaced by COP1, and the resin substrate in Sample 1 was replaced by an acrylic resin exhibiting moisture absorption (DELPET 70NH having a saturation absorption coefficient of 1.71%, produced by Asahi Kasei Corp.).

### (1.4) Sample 4

“Sample 4” was prepared similarly to preparation of Sample 1, except that the resin film in Sample 1 was replaced by an acrylic resin (ACRYPLEN having a thickness of 75 μm), and the resin substrate in Sample 1 was replaced by an acrylic resin exhibiting moisture absorption (DELPET 70NH having a saturation water absorption coefficient of 1.71%, produced by Asahi Kasei Corp.).

### (1.5) Sample 5

“Sample 5” was prepared similarly to preparation of Sample 1, except that the resin film in Sample 1 was replaced by an acrylic resin (ACRYPLEN having a thickness of 75 μm, produced by Mitsubishi Rayon Co., Ltd.), and the resin substrate in Sample 1 was replaced by PDMS (Polydimethyl siloxane, TSE200, produced by Momentive Performance Materials Japan Inc.).

### (2) Evaluation of Sample

In order to fill water in a flow path in each of Samples 1-5, and subsequently to freeze the sample in the flow path during analysis employing terahertz light, each of Samples 1-5 was cooled employing an external cooling apparatus to freeze water as a liquid sample.

Thereafter, each of Samples 1-5 was placed in an analysis system of either one of the two, a transmission type and a reflection type (refer to FIG. 4 and FIG. 6), and exposed to visible light or terahertz light to measure light source intensity and light intensity from the inside of a chip, and to make evaluations in accordance with the following ranks. The measured results (including materials for Samples 1-5, and types for the analysis system) are shown in Table 1.

### Ranks

A: Transmission light intensity or reflection light intensity from the inside of a chip is 80% or more in comparison to light source intensity.

B: Transmission light intensity or reflection light intensity from the inside of a chip is 50% or more and less than 80% in comparison to light source intensity.

C: Transmission light intensity or reflection light intensity from the inside of a chip is less than 50% in comparison to light source intensity.

TABLE 1

| | | Sample 1 | Sample 2 | Sample 3 | Sample 4 | Sample 5 |
|---|---|---|---|---|---|---|
| Process | | (Ex.) | (Ex.) | (Ex.) | (Comp.) | (Comp.) |
| — | Resin film | Fluorine resin | COP1 | COP1 | Acrylic resin | Acrylic resin |
| | (material) | | | | | |
| — | Resin | COP1 | COP1 | Acrylic resin | Acrylic resin | PDMS |
| | substrate | | | | | |
| | (material) | | | | | |
| Process 1 | Visible light | Reflection | Transmission | Reflection | Reflection | Transmission |
| (those | measure- | type | type | type | type | type |
| corresponding | ment type | | | | | |
| to Process 1) | Material in | COP1 | COP1 | COP1 | Acrylic resin | Acrylic resin |
| | visible light | | | | | and PDMS |
| | optical path | | | | | (Both) |
| Process 2 | Terahertz | Transmission | Transmission | Reflection | Transmission | Transmission |
| (those | light | type | type | type | type | type |
| corresponding | measure- | | | | | |
| to Process 2) | ment type | | | | | |
| | Material in | Fluorine resin | COP1 | COP1 | Acrylic resin | Acrylic resin |
| | terahertz | and COP1 | | | | and PDMS |
| | light optical | (Both) | | | | (Both) |
| | path | | | | | |
| — | Measured | A | A | A | C | C |
| | results of | | | | | |
| | visible light | | | | | |
| | Measured | A | A | A | C | C |
| | results of | | | | | |
| | terahertz | | | | | |
| | light | | | | | |
| | Remarks | | | Light source | | |
| | | | | placed on | | |
| | | | | resin film | | |
| | | | | side | | |

Ex.: Example,
Comp.: Comparative example

### (2.1) Sample 1

As to Sample 1, when measuring it employing visible light, “reflection type” analysis system is utilized (COP1) twice. Since COP1 has a small saturation water absorption coefficient of 0.01%, no crack derived from water content is generated in a resin substrate even though a sample inside a flow path is frozen, resulting in no problem to transmission employing even visible light.

On the other hand, when measuring it employing terahertz light, “transmission type” analysis system is utilized, materials in the transmission optical path are two kinds of COP1 and a fluorine resin. The fluorine resin has a saturation water absorption coefficient of 0.01%, and no crack derived from water content is generated in the resin substrate and the resin film even though a sample inside the flow path is frozen.

### (2.2) Sample 2

As to Sample 2, the material transmitted by both visible light and terahertz light is cycloolefin polymer (COP1) which has a small saturation absorption coefficient of 0.01″. For this reason, no crack is generated in the resin substrate even though a sample inside a flow path is frozen, resulting in no problem to transmission employing even visible light.

### (2.3) Sample 3

As to Sample 3 different from Sample 1 and Sample 2, a resin film is placed on the incident side of visible light, and the visible light has been designed to enter from the resin film side.

In this case, when measuring it employing visible light, “reflection type” analysis system is employed, and a material in the transmission optical path is made of only COP1. COP1 has a small saturation water absorption coefficient of 0.01%. For this reason, no crack derived from water content is generated in a resin substrate even though a sample inside a flow path is frozen, resulting in no problem to transmission employing even visible light.

On the other hand, when measuring it employing terahertz light, terahertz light has a wavelength range between 100 μm and 1 mm, the crack is smaller in size than the wavelength, resulting in almost no influence from scattering.

### (2.4) Sample 4

As to Sample 4, the resin substrate and the resin film each are made of a resin having a saturation water absorption coefficient of more than 1.0%. When measuring it employing visible light, “reflection type” analysis system is employed, and visible light is incident from the resin substrate side. The material in a transmission light optical path is only an acrylic resin. Since the acrylic resin is in a state of water absorption, microcrack (a phenomenon by which milky white is visualized because of presence of refractive index difference via freezing of water content) is generated during freezing, whereby sufficient visible light intensity can not be obtained for the measurements.

On the other hand, when measuring it employing terahertz light, “transmission type” analysis system by which terahertz light enters from the resin substrate, and passes through the resin film is employed, and materials in the transmission optical path are an acrylic resin, a sample having become ice, and an acrylic resin in order. The acrylic resin possesses a C—O bond in the molecule, and is easy to contain water. As to water absorption, with terahertz light, influence thereof becomes smaller during freezing, but intensity thereof is exponentially reduced, depending on the thickness. Accordingly, in the case of Sample 4 in which an acrylic resin is present in the optical path, the intensity has been largely reduced.

### (2.5) Sample 5

As to Sample 5, when measuring it employing visible light, “transmission type” analysis system is employed, visible light is incident from the resin substrate side. The resin substrate has a considerably small water absorption coefficient of 0.02%, but has a large moisture permeability degree of 110 g/mm2·24 Hr (at 40° C. and 90% RH). Water vapor dispersed in a resin is frozen, and visualized to be milky white, when this resin substrate is frozen. For this reason, sufficient visible light intensity was not able to be obtained in this measurement.

On the other hand, when measuring it employing terahertz light, for the same reason as that of Sample 4, sufficient terahertz light intensity was not able to be obtained.

### (3) Wrap-Up

As described above, when only a member made of a cycloolefin in the propagation path for visible light or terahertz light is placed, evaluated results are excellent, and it is to be understood that it is effective for inhibiting generation of crack that the member in an optical propagation path in the resin substrate is made of a cycloolefin resin.

### EXPLANATION OF NUMERALS

1 Microanalysis chip
10 Resin film
20 Resin substrate
22 Flow path groove
24 Bonding surface
26 Fine flow path
30 Inflow•outflow opening
40,45 Analysis system
50 Light source
50a Visible light source
50b Terahertz light source
60 Filter
70 Reflection mirror
72 Mirror made of Si
80 Detector
80a Visible light detector
80b Terahertz light detector
90 Dichroic mirror
100 Objective lens

1. A sample analyzing method employing a microanalysis chip comprising a substrate in which a groove is formed, and a lid body to cover the groove, one selected from the group consisting of the substrate and the lid body, the one made of a cycloolefin resin, comprising:
step 1 of exposing a sample to visible light passing through the one, and making light transmitted or reflected from the sample to pass through the one to conduct sample analysis via measurement of the transmitted visible light; and
step 2 of making terahertz light to pass through the substrate or the lid body to expose the sample to the terahertz light, and making light transmitted or reflected from the sample to pass through the lid body or the substrate to conduct sample analysis via measurement of the transmitted light.

2. The sample analyzing method of claim 1,
wherein the step 2 is a step of making the terahertz light to pass through the substrate or the lid body made of the cycloolefin resin to expose the sample to the terahertz light, and making light transmitted or reflected from the sample to pass through the substrate or the lid body to conduct sample analysis via measurement of the transmitted light.

3. The sample analyzing method of claim 1,
wherein the cycloolefin resin has a water absorption coefficient of 0.01% or less.

4. A microanalysis chip employed in the sample analyzing method of claim 1, comprising the substrate in which the groove is formed, and the lid body to cover the groove,
wherein at least one of the substrate and the lid body is made of a cycloolefin resin.
